(19) United States
(12) Patent Application Publication
(10) Pub. No.: US 2009/0032322 A1
(43) Pub. Date: Feb. 5, 2009

(54) Preemptive Torque Control of a Secondary Axle to Optimize Traction

(75) Inventor: Brian B. Ginther, Rochester Hills, MI (US)

Correspondence Address: WARN, HOFFMANN, MILLER & LALONE, .P.C, PO BOX 70098, ROCHESTER HILLS, MI, 48307, US

(73) Assignee: BORGWARNER INC., AUBURN HILLS, MI (US)

(21) Appl. No.: 12/224,118

(22) PCT Filed: Mar. 7, 2007
(86) PCT No.: PCT/US2007/005862

§ 371 Date: Aug. 18, 2008

Related U.S. Application Data
(60) Provisional application No. 60/779,937, filed on Mar. 7, 2006.

(51) Int. Cl. B60K 28/16; B60K 17/354

(52) U.S. Cl. 180/197; 180/247

(57) ABSTRACT

A method of preemptively applying torque to a secondary axle of an all wheel drive vehicle is provided. A determination is made of a preemptive torque value based at least upon throttle rate. A determination is made if a minimum throttle rate has been met. If the minimum throttle rate is met, a controller preemptively applies preemptive torque value to the secondary axle.

### CROSS-REFERENCE TO RELATED APPLICATIONS

This application claims the benefit of U.S. Provisional Application No. 60/779,937, filed Mar. 7, 2006.

### FIELD OF THE INVENTION

The present invention relates to a method for controlling torque transferred by an engine to a secondary axle of an all wheel drive (AWD) vehicle and a vehicle so controlled.

### BACKGROUND OF THE INVENTION

All wheel drive vehicles have a primary axle and a secondary axle. For purposes of fuel consumption, during normal vehicle operation the primary axle is typically exclusively powered by the engine. For improved vehicle handling purposes, certain vehicle operating conditions will cause torque to be delivered through a coupling to a secondary axle. Usually the amount of torque delivered to the secondary axle is adjustable and is controlled by a controller. The conditions which cause torque to be delivered to the secondary axle can include loss of traction due to poor road conditions, an apportioning of torque to the secondary axle for better handling due to the speed of the vehicle, a loss of traction of tire wheels on the primary axle due to vehicle acceleration.

Typically when the control system delivers torque to the secondary axle due to tractional losses during vehicle acceleration, the torsional engagement of the secondary axle occurs only after sensors on the primary axle wheels notice a slip condition. Accordingly, there is a slight delay before torque is transferred to the secondary axle to alleviate a primary axle slip condition. It is desirable to provide an AWD system wherein the aforementioned delay can be materially reduced or eliminated.

### SUMMARY OF THE INVENTION

The present invention provides an AWD system wherein the activation delay can be materially reduced or eliminated when the vehicle is accelerated into a potential primary axle slip condition.

Other features of the present invention will be more apparent to those skilled in the art as the invention is further described in the accompanying drawings and detail description.

### BRIEF DESCRIPTION OF THE DRAWINGS

FIG. 1 is schematic diagram of a motorized vehicle in accordance with an embodiment of the present invention.

FIG. 2 is a schematic flowchart of the logic for the timer of the control system of the present invention.

FIG. 3 is a schematic flowchart of the preempt torque reset logic of the present invention.

FIG. 4 is a flowchart of the preempt torque set logic according to the present Invention.

### DETAILED DESCRIPTION OF THE PREFERRED EMBODIMENTS

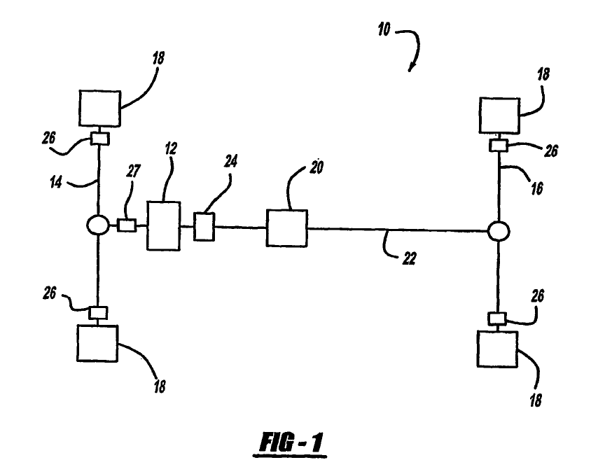

Referring to FIG. 1, a vehicle implementing a preemptive torque control system is generally shown at 10. The vehicle 10 has an engine 12 which is operably connected to a front axle 14 and a rear axle 16. The vehicle 10 is an all-wheel drive (AWD) vehicle, wherein the engine 12 transfers torque to both the front axle 14 and rear axle 16. In an AWD vehicle the engine 12 provides torque to a primary axle or front axle 14 and a secondary axle or rear axle 16. However, it should be appreciated that the primary axle can be the rear axle 16 and the secondary axle to be the front axle 14. By way of explanation and not limitation, for description purposes below, the front axle 14 is the primary axle and the rear axle 16 is the secondary axle.

Wheels 18 are placed at both ends of the front axle 14 and rear axle 16. Thus, as torque is applied to the axles 14, 16 from the engine 12, the axles 14, 16 rotate which causes the wheels 18 to rotate and allows the vehicle 10 to move. A coupling 20 is placed on a drive shaft 22 between the engine 12 and the rear axle 16 for operably connecting the engine 12 and the rear axle 16. A control unit 24 is then used to control the amount of torque applied to the rear axle 16 through the coupling 20. Further, sensors 26 are placed on the vehicle 10 in order to determine vehicle operating conditions, with which the data from the sensors 26 is then transmitted to the control unit 24. Thus, the sensors 26 are interfaced or connected to the control unit 24. The control unit 24 determines the amount of torque applied by the engine 12 to the front axle 14 and rear axle 16. The amount of torque transferred from the engine 12 to the axles 14, 16 is controlled by a throttle 27 which is typically operated via a pedal by a driver of the vehicle 10. Thus, depending on the position of the throttle 27 and the rate of change of the position of the throttle 27, otherwise known as the throttle 27 rate, the amount of torque transferred from the engine 12 to the axles 14, 16 is altered.

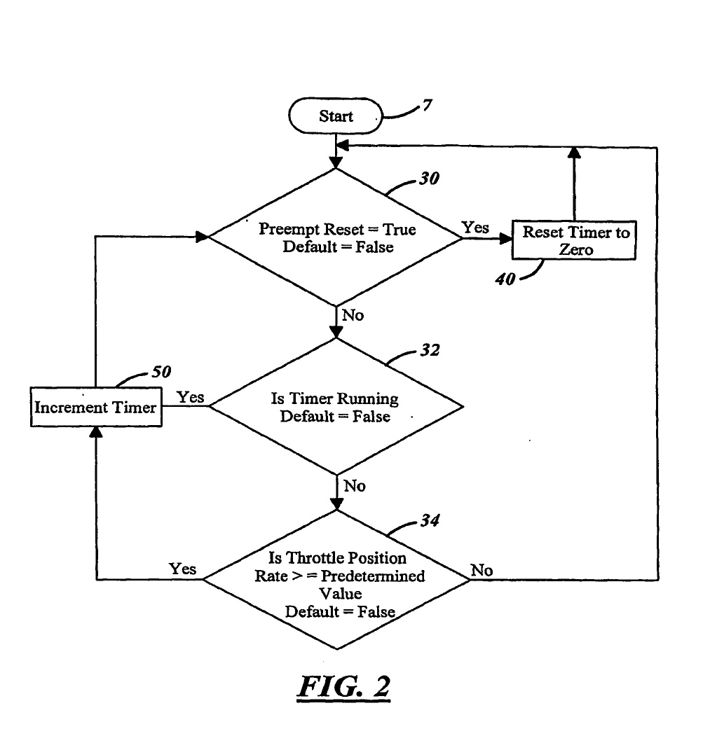

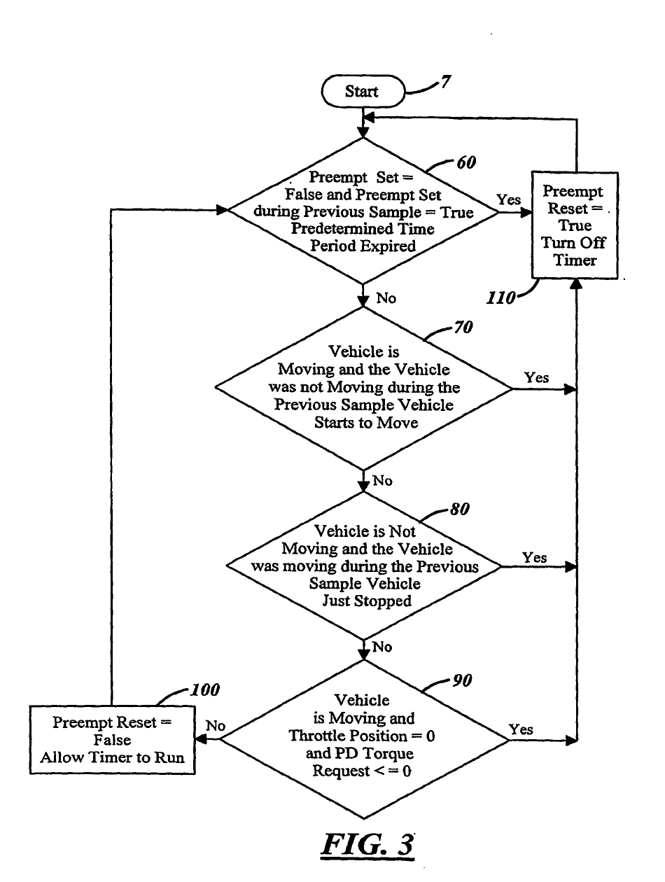

FIG. 2 illustrates the control system that controls the timer 50 for the preemptive torque. The preempt torque timer logic circuit starts within the starting of the engine at the start function 7. Start function 7 then goes to a decision function 30. Decision function 30 inquires if the preemptive torque timer is to be reset (preempt reset=true). The default value for decision function 30 is false. If decision function 30 is false, then the logic will go to decision function 32. Decision function 32 inquires if the timer 50 is running. The default position for decision function 32 is false; accordingly, the logic will proceed to decision block 34. Decision function 34 inquires if the rate of activation of the throttle is beyond a predetermined value. The default position for decision function 34 is no. It should be noted that as used in this invention the throttle rate generally corresponds to the rate of angular travel of the accelerator pedal although they need not be a directly proportional relationship. Decision function 34 has a default value of being false and accordingly if the vehicle driver does not push the accelerator pedal down fast enough, logic will revert back to decision box 30. If the vehicle driver has caused the vehicle throttle to be increased beyond a predetermined value, decision function 34 will render a yes response and will accordingly turn on the increment timer 50. The increment timer 50 will then signal to the decision function 30 that it is running. Decision function 30 will only change to a true if the preemptive torque timer reset has started. The preemptive torque timer reset is controlled by the flowchart logic shown in FIG. 3. The default value for preemptive torque timer reset is false so accordingly as the timer 50 is turned on decision function 30 loop down to decision function 32. Since the timer 50 is now running, decision function 32's logic will proceed back to the timer 50 and this will cause a continuous loop to occur until the preemptive torque timer reset has been activated to true. When the preemptive torque timer reset has been activated to true, decision function 30 will yield a yes in logic going to decision function 40 causing the timer 50 to be reset to zero. Accordingly, the timer 50 will be started by the throttle being accelerated beyond a predetermined rate of acceleration and the timer 50 will only be reset to zero upon the satisfaction of one of the control logic functions provided in FIG. 3.

FIG. 3 illustrates the logic used in the control system to reset the clock 50. The logic of the control system will start upon the starting of the engine shown as the start function 7. Typically both the timer logic and the reset preemptive torque time logic will be recalculated at five millisecond intervals. In the decision function 60 an inquire will be made if the preemptive torque timer set is false and if the preemptive torque timer set during the previous sample time period was true. The default value for decision function 60 will be negative and decision function 60 will only be true if the timer 50 has run past a predetermined time period as to be explained later. If the result of decision function 60 is negative then the logic goes to decision function 70. Decision function 70 will only be positive if the vehicle is moving and the vehicle was not moving during the previous sample time period which as explained previously will typically be around five milliseconds. Decision function 70 will only be activated to a yes if the vehicle starts to move. If the vehicle is not moving then the logic from decision function 70 proceeds onto decision function 80. Decision function 80 will only give a yes result if the vehicle was moving during the previous five milliseconds and the vehicle is now stopped. Accordingly, decision function 80 will only be activated when the vehicle comes to a stop. The logic then proceeds onto decision function 90. Decision function 90 will be no unless three separate conditions are met. The first condition at decision function 90 is that the vehicle must be moving. The second condition of decision function 90 is that the throttle position is equal to zero. The third condition for decision function 90 is that the preemptive torque request as to be explained later is equal or less than zero. This condition will only occur when the vehicle operator has pulled their foot up on the accelerator to cause the accelerator pedal to come to the zero position. If the result of decision function 90 is negative the logic will go to the preemptive torque reset being false function 100. The effective result of the preemptive reset being false is to allow the timer 50 to continue to run. If there is a yes result to decision functions 60, 70, 80 or 90, the effect will be to cause the preemptive reset to be true thereby effect is that of turning off the timer function 110.

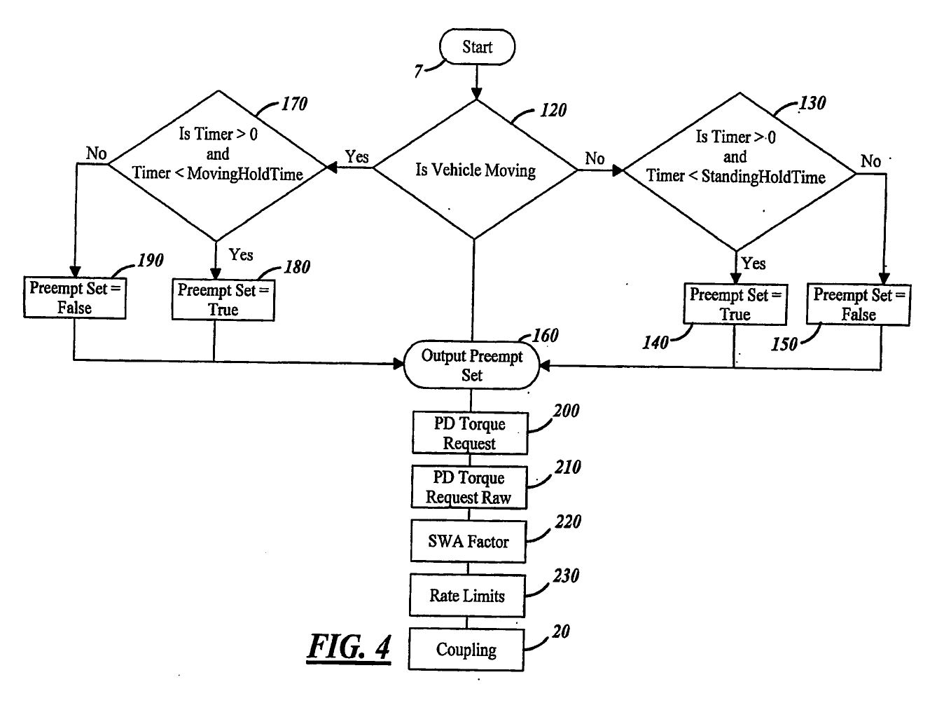

FIG. 4 is a flowchart of the logic for the preemptive torque set logic. Preemptive torque set is essentially the logic used to set the amount of torque which is delivered to the secondary axle via the coupling 20. The preempt set logic is started with the starting of the engine and cycles approximately every five milliseconds. In decision function 120, an inquiry is made is the vehicle moving. If the vehicle is not moving then the logic goes to the decision block 130. At decision function 130 the first Inquiry is if the timer 50 is started. The second thing that must be true for the output of decision function 30 to be true is that the time counted by the timer 50 is below a first predetermined or standing hold time. The standing hold time will typically be a period long enough to be significant, but short enough such that several operator inputs to the vehicle operation cannot be made in a shorter period. Practice has shown a typical time period of about 0.5 seconds is a preferred value for the standing hold time. If a timer 50 is running in the standing hold time of 0.5 second has not expired, the logic will then go down to decision function 140 wherein the preempt set will be set as true. If the timer has exceeded the first predetermined time frame then the logic will proceed to decision function 150 setting the preemptive set to be false. A preempt set equal to false will cause the output preempt set in decision function 160 to be zero. A preempt set true precedes through function 140 will cause certain calculations to be made in the output preempt set function 160. Going back to decision function 120 if a vehicle is moving the logic will then proceed to decision function 170. A decision function 170 two Inquiries are made which must true. The first inquiry is the timer 50 activated. The second inquiry is has the timer value less than a second predetermined value which is the moving hold time. If the timer is running and has not counted past the second predetermined time, the result of decision block 170 will be yes and the preemptive set true function block 180 will then be fed to the output preemptive set 160. If the timer has not been turned on or if the timer has exceeded the second predetermined value the output from decision function 170 will go through decision function 190 and the preempt set will be false. If the predetermined or the preempt set is true from function 180 or 140 the control system will calculate the pd torque request. The pd torque request is a function which it equal kp times throttle position+kd times the throttle position rate. Kp and kd can differ from one another or be equal at a given speed. The pd torque request is limited to a range of zero to X, a tunable value typically in a range of 300 Newton meters for a typical passenger vehicle however, it may be lower or greater for certain vehicles. The kp is a function of the vehicle speed, the kd is a function of the vehicle speed. Both kp and kd are table based values which are selected for certain vehicles. From calculation box 200, the pd torque request is then submitted to the pd torque request raw calculation box 210. Pd torque request raw is equal to the greater of the current pd torque request or the previous pd torque request taken five milliseconds prior. The net effect of the pd torque request raw is that pd torque request will always be equal or greater as time proceeds even though a current value of the torque request may fluctuate up or down during any given time. The pd torque request is then multiplied by a SWA factor in multiplier function 220. Multiplier function 220 calculates a SWA factor which is based upon the steering wheel angle of the vehicle. Since most all wheel drive vehicles do not have a differential between the two separate axles but only has differentials between the wheels on each axle, it is desirable to limit excessive torque to the secondary axle under hard steering angles maneuvering operations to prevent tire skid or turning skid on the wheels. After proceeding through the SWA factor, which will be 1 if the vehicle is going straight and will be less than 1 if the steering wheel is being turned, the pd torque request will then be multiplied by a rate limit in function block 230. Function block 230 will usually have no rate limit for positive increases in requested preemptive torque. Request for lowering of the preemptive torque will be rate limited so that there is not a sudden release of torque supplied to the secondary axle. The lowering request occurs when the preemptive set equals false from functions 150 or 180.

In operation the timer 50 will not be started until the throttle is pushed down beyond a predetermined rate (decision function 34). If the vehicle is stationary when the timer is started, the preempt set logic will go from decision function 120 to decision function 130. When the timer 50 is first started, decision function 30 will have a time on the timer which is less than that of the standing hold time which typically is 0.5 seconds. Decision function 130 will give a true response causing decision function 140 to set the preempt set to be true proceeding onto the output preempt set 160. A pd torque request will be calculated in function 200. The above noted calculation will then be used to calculate a preemptive torque request raw in calculator function 210. A SWA factor will modify the pd raw torque request based upon the steering wheel angle in function 220. If the request is continually increasing, there will be no rate limit in calculation function 230 and the coupling 20 will be engaged to meet the request. The above noted preemptive torque request will be continuously calculated up to the expiration of the standing hold time. When the standing hold time is met, decision function 60 will activate the preempt reset 110 which causes the timer 50 to be cut off. Also, movement of the vehicle will cause the preemptive reset to be true causing the timer 50 to be cut off. If the vehicle starts to move and the throttle position is not returned to zero or if the preemptive torque request is not equal to zero then the timer will be restarted and logic box 120 will have a yes response causing the timer to be restarted by decision function 180 to the second hold time. Preemptive torque is continually applied by the coupling 20 until the expiration of the second predetermined time. Preemptive torque will only be applied for a maximum of the first and second predetermined time periods which will be approximately 1.1 seconds. After such time, other control systems will apply torque to secondary wheels as required by the remainder of the AWD control system for the vehicle. The benefit of the preemptive torque is that torque will be applied to the secondary axle before any sense of slipping in the wheels is experienced by the sensors.

While preferred embodiments of the present invention have been disclosed, it is to be understood it has been described by way of example only, and various modifications can be made without departing from the spirit and scope of the invention as it is encompassed in the following claims.

What is claimed is:

1. A method of controlling torque directed to a secondary axle of an all wheel drive vehicle comprising:
determining a preemptive torque value based upon at least a variable of throttle rate;
determining if the throttle rate is greater than a predetermined value; and
preemptively engaging said secondary axle with said preemptive torque value.

2. A method as described in claim 1 further including determining said preemptive torque value additionally upon a variable of throttle position.

3. A method as described in claim 1 further including determining said preemptive torque value dependent a variable of vehicle speed.

4. A method as described in claim 1 further including modifying said preemptive torque value based upon a steering wheel angle of said vehicle.

5. A method as described in claim 1 further including holding said preemptive torque value for a first predetermined point of time if said vehicle is not moving.

6. A method as described in claim 5 further including holding said torque value a second predetermined period of time if said vehicle starts to move.

7. A method as described in claim 6 wherein said first and second predetermined time values are switched upon vehicle movement.

8. A method as described in claim 1 further including ramping down any decrease in preemptive torque value.

9. A method as described in claim 1 wherein said preemptive torque is tuned off if a throttle position is less than zero.

10. A method as described in claim 1 wherein said preemptive torque is tuned off if a throttle position is less than zero and said throttle rate is equal or less than zero.

11. A method as described in claim 1 wherein said preemptive torque is turned off if a throttle position is less than zero and said throttle rate is equal or less than zero and said vehicle is moving.

12. A method as described in claim 1 wherein said preemptive torque is cut off if said vehicle comes to a stop.

13. A method as described in claim 1 wherein preemptive torque value is continually calculated and wherein said preemptive torque value is utilized to derive a raw preemptive torque value and said raw preemptive torque value equals the greater of the current preemptive torque value or the preemptive torque value in a time period prior to a current time period of preemptive torque value.

14. A method of controlling torque directed to a secondary axle of an all wheel drive vehicle comprising:
determining a preemptive torque value based upon at least a variable of throttle rate modified by a first value based upon vehicle speed, and a variable of throttle position modified by a second value based upon vehicle speed;
determining if the throttle rate is greater than a predetermined value; and
preemptively engaging said secondary axle with said preemptive torque value.

15. A method as described in claim 14 wherein said first and second values differ from one another.

16. A method as described in claim 14 further including holding said preemptive torque value for a first predetermined point of time if said vehicle is not moving.

17. A method as described in claim 16 further including holding said torque value a second predetermined period of time if said vehicle starts to move.

18. A method as described in claim 1 further including ramping down any decrease in preemptive torque value.

19. A method as described in claim 14 wherein preemptive torque value is continually calculated and wherein said preemptive torque value is utilized to derive a raw preemptive torque value and said raw preemptive torque equals the greater of the current preemptive torque value or the preemptive torque value in a time period prior to a current time period of preemptive torque value.

20. An all wheel drive vehicle having a primary axle and a secondary axle torsionally powered to an engine via a coupling controlled by a controller, said controller:
determining a preemptive torque value based upon at least a variable of throttle rate;
determining if the throttle rate is greater than a predetermined value; and
preemptively engaging said secondary axle with said preemptive torque value.
